(19) United States
(12) Patent Application Publication
(10) Pub. No.: US 2018/0075469 A1
(43) Pub. Date: Mar. 15, 2018

(54) MOBILE DEVICE ADVERTISEMENT SYSTEM

(71) Applicant: Joseph Dichiara, Scottsdale, AZ (US)

(72) Inventor: Joseph Dichiara, Scottsdale, AZ (US)

(21) Appl. No.: 15/698,444

(22) Filed: Sep. 7, 2017

Related U.S. Application Data
(60) Provisional application No. 62/394,003, filed on Sep. 13, 2016.
(60) Provisional application No. 62/507,689, filed on May 17, 2017.

(51) Int. Cl. G06Q 30/02; H04W 4/02

(52) U.S. Cl. CPC G06Q 30/0214; G06Q 30/0261; G06Q 30/0267; H04W 4/021

(57) ABSTRACT

A mobile device advertisement system is provided. The system includes a business computer located at a business, a mobile device operated by an advertising customer, and a server located at a service provider. The server is coupled to the business computer and the mobile device. The server is programmed to receive and store from the business computer business profile information and to receive and store from the mobile device customer profile information. The server is also programmed to receive from the mobile device a request to advertise for the business and in response generates and transmits instruction for automatic execution to the mobile device a geo fence with a predetermined radius based on the stored business information and push instructions for pushing an advertisement from the mobile device of the advertising customer to mobile devices of potential customers within the geo fence.

### CROSS REFERENCE TO RELATED APPLICATION'S

This application claims priority to U.S. Provisional patent application entitled “MOBILE DEVICE ADVERTISEMENT SYSTEM,” Ser. No. 62/394,003, filed Sep. 13, 2016, and claims priority to U.S. Provisional patent application entitled “MOBILE DEVICE ADVERTISEMENT SYSTEM,” Ser. No. 62/507,689, filed May 17, 2017, the disclosures of which are hereby incorporated entirely herein by reference.

### BACKGROUND OF THE INVENTION

### Technical Field

This invention relates generally to an advertisement system and more particularly to a mobile device advertisement system.

### State of the Art

The use of advertisements has long been established and further the use of advertisements on mobile devices has and continues to become a more common way for companies to advertise their services. Often, the companies utilize other applications, such as social media applications, advertisements on other applications, payment for placement on web searches and all options for putting the company's goods or services in front of potential customers.

These systems lack the ability to communicate directly with customers through other customers and further lack the ability to send offers and advertisements from one customer to another on behalf of the business. These systems lack the ability to advertise directly through customers of the business to other customers of the business. Instead, these conventional methods of advertising on mobile devices leave the ability to reach consumers strictly to searches or random luck in getting the advertisement to a potential customer.

Accordingly, there is a need for an improved advertisement system utilizing mobile devices.

### SUMMARY OF THE INVENTION

The present invention relates to a mobile device advertisement system that allows customers to provide advertisement on behalf of a company or other entity about places, products, and/or services that the customer has had positive experiences with, wherein the customer who advertises obtains rewards for participating.

An embodiment includes a mobile device advertisement system comprising: a business computer located at a business; a mobile device operated by an advertising customer; and a server located at service provider, the server coupled to the business computer and the mobile device, the server programmed to: receive from the business computer business profile information and automatically store the business profile information; receive from the mobile device customer profile information and automatically store the customer profile information; receive from the mobile device a request to advertise for the business and retrieve and process the stored business information and the stored customer information to establish an advertisement relationship; and generate and transmit instruction for automatic execution to the mobile device a geo fence with a predetermined radius based on the stored business information and push instructions for pushing an advertisement from the mobile device of the advertising customer to mobile devices of potential customers within the geo fence.

Another embodiment includes a mobile device award system comprising: a business computer located at a business; a mobile device operated by an advertising customer; and a server located at service provider, the server coupled to the business computer and the mobile device, the server programmed to: receive from the business computer business profile information and automatically store the business profile information; receive from the mobile device customer profile information of the advertising customer and automatically store the advertising customer profile information; receive from the mobile device a request to supply award from the business and retrieve and process the stored business information and the stored advertising customer information to establish an advertisement relationship; and generate and transmit instruction for automatic execution to the mobile device a geo fence with a predetermined radius based on the stored business information and push instructions for pushing an award from the mobile device of the advertising customer to mobile devices of potential customers within the geo fence.

Yet another embodiment includes a method of using mobile device advertisement system, the method comprising: creating a business profile with the mobile device advertisement system for a business; creating a special offer for distribution by an advertising customer; establishing a compensation structure for advertising customers; creating a customer profile with the mobile device advertisement system; obtaining products, services or a combination thereof from the business having the business profile with the mobile device advertisement system; preparing a review of the business using a mobile device of the mobile device advertisement system; receiving instructions from a server to establish a geo fence with a predetermined radius; and automatically pushing the advertisement material to a mobile device of potential customers having a customer profile with the mobile device advertisement system when the potential customer enters the geo fence.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a block diagram of a mobile device advertisement system in accordance with embodiments;

FIG. 2 is a block diagram of a mobile device of an advertising customer and a geo fence for use of pushing advertisements to other mobile devices in accordance with embodiments;

FIG. 3 is a flow chart of a method of using a mobile device advertisement system by a business in accordance with embodiments; and

FIG. 4 is a flow chart of a method of using a mobile device advertisement system by an advertising customer in accordance with embodiments.

### DETAILED DESCRIPTION OF EMBODIMENTS OF THE INVENTION

As discussed above, embodiments of the present invention relate to a mobile device advertisement system that allows customers to provide advertisement on behalf of a company or other entity about places, products, and/or services that the customer has had experiences with, wherein the customer who advertises obtains rewards for participating.

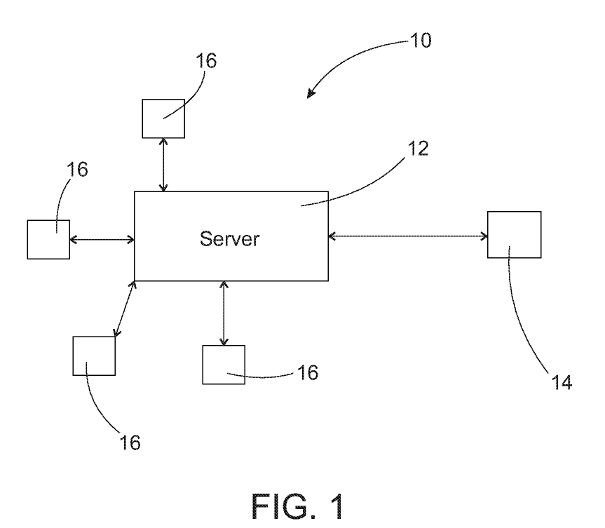

FIG. 1 depicts a mobile device advertisement system 10 according to an embodiment of the present invention. The system 10 includes a server 12 located at or operated by or under the direction of an entity operating the system 10. The server 12 may be coupled to a business computer 14 and further may be coupled to one or more mobile devices 16. The server 12 may be coupled to the business computer 14 and to the mobile devices 16 through any type of network connection, including, but not limited to, a local area network (LAN) or a wide area network (WAN), or the connection may be external (for example, through the Internet using an Internet Service Provider).

A business utilizing the system 10 may include the business creating a profile on the mobile device advertisement system. Creating a profile by the business includes, without limitation, entering all pertinent profile information, such as but not limited to a business name, an address, a phone number, an email address, a user name, a password, hours of operation, type of place, products, and/or services provided from the business, and the like. The business profile may be created through the business computer 14, wherein the business computer 14 sends the profile information to the server 12, and wherein the server 12 receives and automatically stores the profile information. The profile information may be accessed, and retrieved by the server 12 in order to automatically determine categories and/or sections that business will be associated with that consumers may search for. The business may utilize the business computer 14 to access the server and update and/or change the profile information. It should be understood that the business may be a company, a corporation, an individual, a sole practitioner, a partnership and any other entity offering a place to visit, services, products and the like. For example and without limitation, the business may be a local restaurant, a business providing a Broadway show, a great handyman or even an online product.

A consumer operating a mobile device 16 may utilize a mobile application that establishes a connection with the server 12. The customer may then create a profile using the mobile application or through a webpage or the like accessed on the customer's mobile device. Creating a profile by the customer includes, without limitation, entering all pertinent customer profile information, such as but not limited to a name, an address, a phone number, an email address, a user name, a password, and the like. The customer profile may be created through the mobile device 16, wherein the mobile device 16 sends the customer profile information to the server 12, and wherein the server 12 receives and automatically stores the customer profile information. The customer profile information may be accessed, and retrieved by the server 12 during operation of the system 10. User launches the app and logs in to system 10 and sees various attractive offers and plans to take advantage of them.

The mobile device 16 may send and the server 12 may receive a search for places, products and/or services. The server 12 may then process the search request and generate and deliver to the mobile device 16 results related to the search request, wherein the results include past satisfied customer reviews of places, products and/or services offered by a business.

A customer who has interacted with a business, such as visiting a place, purchasing a product, and/or receiving services from the business, may utilize a mobile device 16 to access the system 10 through a mobile application or even through a webpage to establish a connection and be coupled to the server 12. The customer may search for his/her feed or categories to see which live offer that is attractive to him/her. He/she places that offer in his/her digital queue, digital cart, digital wish list, or the like, which will save the offer until he/she is ready to use or act upon it. Upon purchase the sharing of the offer through his/her geo-fence is activated.

A customer may now choose to advertise about the product or service from a business that has been updated on the customer profile information. The customer, upon choosing to advertise becomes an advertising customer, wherein other users of the system 10 may see the advertisements that the customer is actively pushing. As soon as the advertising customer clicks “Share” or other type of award sharing button, a geo-fence is automatically created around the advertising customer by the system 10. Now the advertising customer may place the system 10 operating as an app on his/her mobile device in the background and start performing his/her usual tasks, walking around and going about the day as normal. Since the system 10 is in operating in the background at this point, the location of the user is always updated to the current location of the user. With each location update, the algorithm of the system 10 runs and performs at least the following steps:
1. Algorithm fetches all the offers of the user that he has decided to share/push through geo-fence.
2. For each offer, the system 10 obtains the business information and then checks which other users have added this same business information to their personal database of businesses, wherein in at least this way the system 10 generates a list of users already associated with the business and can determine whether to send the offer to particular users already associated with the business in the system 10.
3. The system may then filter these users based on whether the users fall in the geo-fence advertising user's radius or not.
4. The system may push the offer to these filtered users while checking if these filtered users already have that offer pushed to them or not.

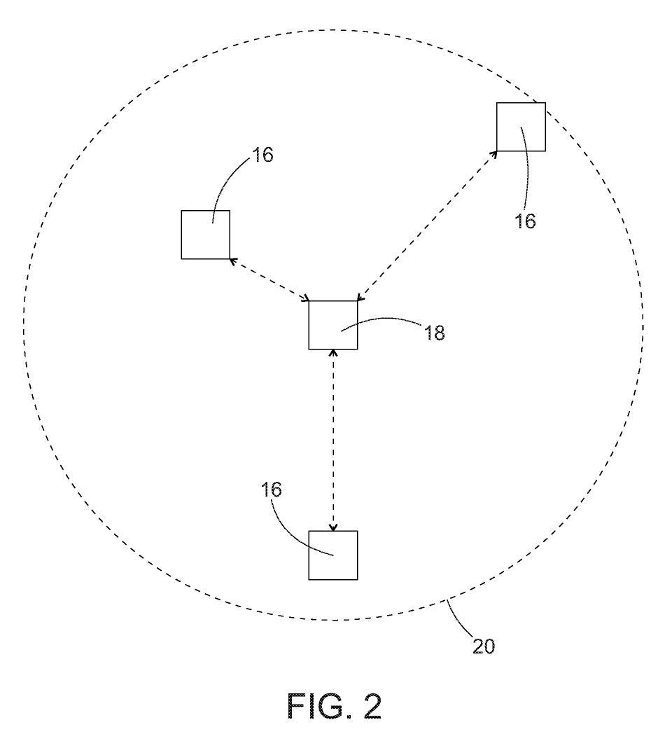

Referring to FIG. 2, the advertising customer may access the system through a mobile application, wherein the mobile application operates on the mobile device 18 and establishes a communication link with the server 12. The server 12 may receive from the mobile device 18 of the advertising customer an advertisement request. The server 12 receives the advertisement request from the mobile device 18 of the advertising customer and automatically generates instructions and transmits the instructions to the mobile device 18, wherein the instructions establish a predetermined radius of a geo fence 20 around that advertising customer's mobile device 18. As the advertising customer moves around during his or her daily activities, potential customers that come into proximity of the advertising customer by entering the geo fence 20 will have the advertisement pushed into a search feed from advertising customer's mobile device 18 to potential customer's mobile application operating on the potential customer's mobile device 16.

In some embodiments, the business through the business computer 14 may provide special offers for use by the advertising customer. In these embodiments, the advertising customer may also include a digital offer having identification information specifically for the advertising customer, wherein the potential customers that come into proximity of the advertising customer by entering the geo fence 20 will have the advertisement pushed into a search feed from advertising customer's mobile device 18 along with a special offer to the potential customer's mobile application operating on the potential customer's mobile device 16.

The advertising customers may earn money through advertisements that allow the advertising customer to earn a reward or other compensation for the advertising efforts. These rewards may be determined in different ways, such as, but not limited to, the number of mobile devices 16 the advertisement is pushed to, the number of potential customers that visit the business in response to receiving the pushed advertisement from the advertising customer and the like. These rewards may be redeemed for money, discounts, or other types of benefits from the business to the advertising customer.

The advertising customer may also have the ability to obtain a larger geo fence 20. The server 12 of the system 10 may analyze the amount of potential customers that follow or otherwise receive the advertising customer's advertisements from his or her mobile device 18. Business may benefit from an advertising customer with a larger following if that customer has a geo fence 20 with a larger radius. In some embodiments, the business may establish predetermined criteria that when met by an advertising customer, initiates the server 12 to automatically send instructions to the advertising customer's mobile device 18 to expand the radius or the range of the geo fence 20 and further to notify the advertising customer of the expanded geo fence 20. The advertising customer receives a benefit by enabling the advertising customer to push advertisements to a larger number of people and therefore receive a larger amount of points and the business benefits by having a larger reach by an advertising customer that is popular and has a large following.

For example and without limitation, if User A wants to share a offer from his device, the mobile device 18 informs this to the server 12 and the server 12 forms a radius (geo fence 20) around the user's location of a predetermined distance. Now, as User A is moving around a city, the mobile device 18 updates his location to the server 12, so the radius (geo fence 20) keeps moving with the user.

If there are 3 other users within that radius—User B, User C and User D, such as shown by mobile devices 16 in FIG. 2. User B and User C have in their interests the restaurant whose offer User A is pushing. The system 10 will know this because it is stored on the server 12, and the server 12 sees User B and User C are within the radius because the server 12 receives location data for all users from mobile devices 16 or mobile devices 18 all at times, thereby updating locations of all users and pushes out the offer to them. It also sees User D is within the radius but that restaurant is not listed in his interests, so server does not disturb User D.

Now when User B and User C go to separate locations, their radius (geo fence 20) is already created because User A pushed out an offer to them, now when another user comes within that radius (geo fence 20), the offer automatically is pushed to his device and this goes on and on until the offer expires.

The system 10 determines when the offer expires based at least upon the expiry date that is stored on the server 12, and while pushing out offer the server 12 checks for the expiry of that offer too. This is one embodiment of how offers will be distributed among multiple users all over the area and thereby allowing business profits from use of this system 10.

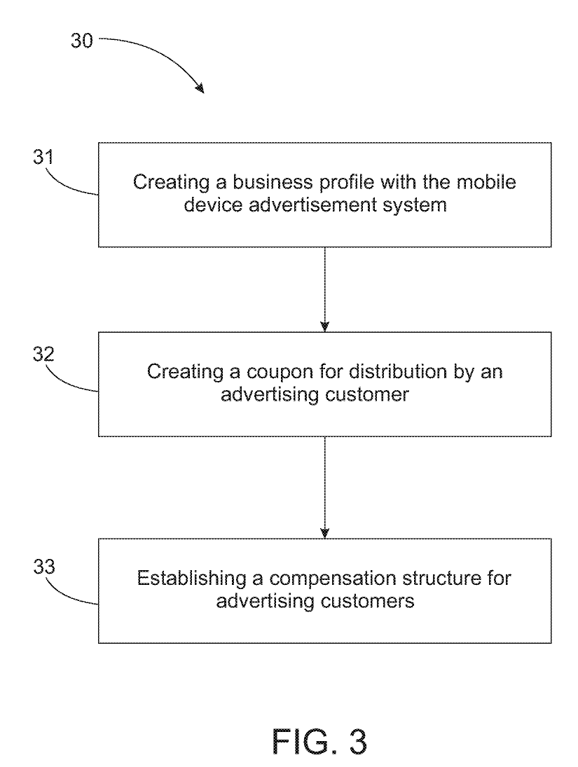

Another embodiment, as shown in FIG. 3 includes a method 30 of using the mobile advertising system by a business. The method 30 includes creating a business profile with the mobile device advertisement system (Step 31); creating a special offer for distribution by an advertising customer (Step 32); and establishing a compensation structure for advertising customers (Step 33). The compensation structure may include the acquisition of points as previously discussed.

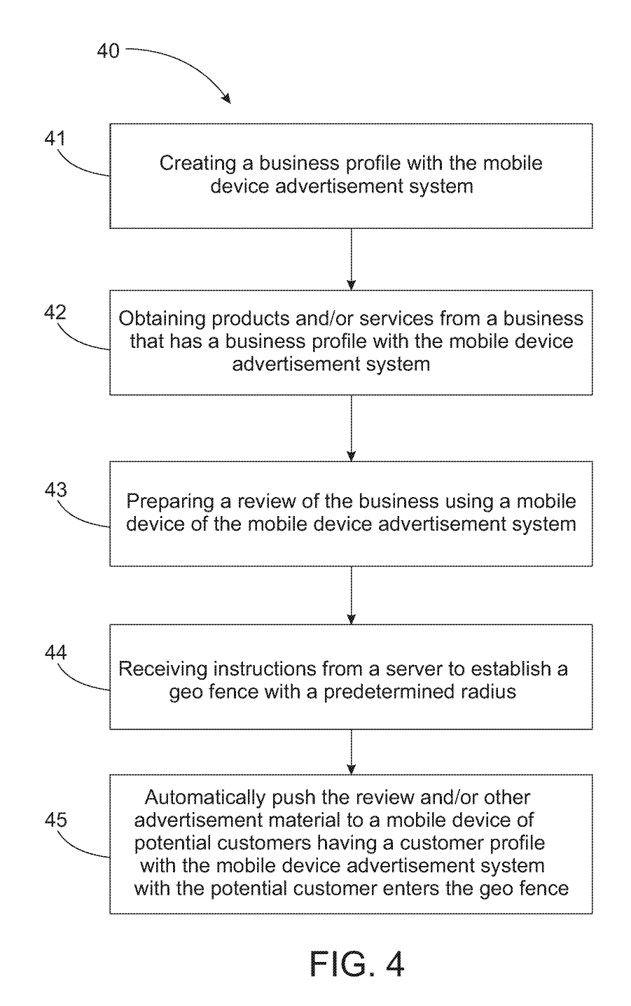

Another embodiment, as shown in FIG. 4 includes a method 40 of using the mobile device advertisement system by an advertising customer. The method 40 includes creating a customer profile with the mobile device advertisement system (Step 41); obtain products and/or services from a business that has a business profile with the mobile device advertisement system (Step 42); preparing a review of the business using a mobile device of the mobile device advertisement system (Step 43); receiving instructions from a server to establish a geo fence with a predetermined radius (Step 44); and automatically push the review and/or other advertisement material to a mobile device of potential customers having a customer profile with the mobile device advertisement system when the potential customer enters the geo fence (Step 45). The other advertisement material may be a special offer for the business.

Further, some embodiments of the system 10 include a social networking feature. The social networking feature operates to create a group of friends to purchase offers with to increase the chance of earning money for the users. Further, the social networking feature includes the ability to communicate and network with people of similar interests in the user's general area. The social networking feature may also allow users to ask and/or answer questions asked regarding a business using the system prior to a purchase (like asking for a real time recommendation).

Another embodiment of the present invention may include the system 10 wherein the customers earn money, rewards or discounts for shopping on an online marketplace, as opposed to a brick and mortar store. The function may be the same as that with brick and mortar business, and offers with the online marketplace may be distributed as other business information using the system 10.

As will be appreciated by one skilled in the art, aspects or components of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A mobile device advertisement system comprising:
a business computer located at a business;
a mobile device operated by an advertising customer; and
a server located at service provider, the server coupled to the business computer and the mobile device, the server programmed to:
receive from the business computer business profile information and automatically store the business profile information;
receive from the mobile device customer profile information and automatically store the customer profile information;
receive from the mobile device a request to advertise for the business and retrieve and process the stored business information and the stored customer information to establish an advertisement relationship; and
generate and transmit instruction for automatic execution to the mobile device a geo fence with a predetermined radius based on the stored business information and push instructions for pushing an advertisement from the mobile device of the advertising customer to mobile devices of potential customers within the geo fence.

2. The system of claim 1, wherein the advertisement is a review of the business associated with the business profile.

3. The system of claim 2, wherein the advertisement includes a special offer for the business associated with the business profile.

4. The system of claim 1, wherein the server is further programmed to award and store points earned by the advertising customer in response to the amount of advertisements pushed to mobile devices of potential customers.

5. The system of claim 1, wherein the server is further programmed to fetch all offers the advertising customer has selected to push through the geo fence.

6. The system of claim 5, wherein the server is further programmed to automatically determine other customers using the system who have added this same business information to the other customers' databases of businesses and automatically, generate a list of customers already associated with the business.

7. The system of claim 6, wherein the server is further programmed to automatically filter the list of customers based to determine which customers from the list of customers are located in the geo fence of the advertising customer.

8. The system of claim 7, wherein the server is further programmed to automatically push the offer to these filtered customers while automatically determining if these filtered customers already have that offer pushed to them.

9. The system of claim 1, wherein the server is further programmed to automatically send instructions to the mobile device of the advertising customer to expand the radius of the geo fence and to notify the advertising customer of the expanded geo fence, wherein the geo fence is expanded in response to the number of customers following the advertising customer.

10. A mobile device award system comprising:
a business computer located at a business;
a mobile device operated by an advertising customer; and
a server located at service provider, the server coupled to the business computer and the mobile device, the server programmed to:
receive from the business computer business profile information and automatically store the business profile information;
receive from the mobile device customer profile information of the advertising customer and automatically store the advertising customer profile information;
receive from the mobile device a request to supply award from the business and retrieve and process the stored business information and the stored advertising customer information to establish an advertisement relationship; and
generate and transmit instruction for automatic execution to the mobile device a geo fence with a predetermined radius based on the stored business information and push instructions for pushing an award from the mobile device of the advertising customer to mobile devices of potential customers within the geo fence.

11. The system of claim 10, wherein the award includes a voucher for the business associated with the business profile.

12. The system of claim 10, wherein the award includes a special offer for the business associated with the business profile.

13. The system of claim 12, wherein the special offer is a time sensitive special offer having a predetermined period of time of availability of the special offer.

14. The system of claim 10, wherein the server is programmed to award and store points earned by the advertising customer in response to the amount of advertisements pushed to mobile devices of potential customers.

15. The system of claim 10, wherein the server is further programmed to fetch all awards the advertising customer has selected to push through the geo fence.

16. The system of claim 15, wherein the server is further programmed to automatically determine other customers using the system who have added this same business information to the other customers' databases of businesses and automatically, generate a list of customers already associated with the business.

17. The system of claim 16, wherein the server is further programmed to automatically filter the list of customers based to determine which customers from the list of customers are located in the geo fence of the advertising customer.

18. The system of claim 17, wherein the server is further programmed to automatically push the offer to these filtered customers while automatically determining if these filtered customers already have that award pushed to them.

19. A method of using mobile device advertisement system, the method comprising:
creating a business profile with the mobile device advertisement system for a business;
creating a special offer for distribution by an advertising customer;
establishing a compensation structure for advertising customers;
creating a customer profile with the mobile device advertisement system;
obtaining products, services or a combination thereof from the business having the business profile with the mobile device advertisement system;
preparing a review of the business using a mobile device of the mobile device advertisement system;
receiving instructions from a server to establish a geo fence with a predetermined radius; and
automatically pushing the advertisement material to a mobile device of potential customers having a customer profile with the mobile device advertisement system when the potential customer enters the geo fence.

20. The method of claim 19, further comprising:
automatically fetching all advertisement material the advertising customer has selected to push through the geo fence and automatically determining other customers using the system who have added this same business information to the other customers' databases of businesses;
automatically generating a list of customers already associated with the business;
automatically filtering the list of customers based to determine which customers from the list of customers are located in the geo fence of the advertising customer; and
automatically pushing the advertisement material to these filtered customers while automatically determining if these filtered customers already have that advertisement material pushed to them.
